(19) United States
(12) Patent Application Publication
(10) Pub. No.: US 2025/0211787 A1
(43) Pub. Date: Jun. 26, 2025

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Yingzhan XU, Beijing (CN); Wenyi WANG, Beijing (CN); Kai ZHANG, Los Angeles, CA (US); Li ZHANG, Los Angeles, CA (US)

(21) Appl. No.: 19/074,279

(22) Filed: Mar. 7, 2025

Related U.S. Application Data
(63) Continuation of application No. PCT/CN2023/116630, filed on Sep. 1, 2023.

(30) Foreign Application Priority Data
Sep. 9, 2022 (WO) PCT/CN2022/118243

(51) Int. Cl. H04N 19/597; H04N 19/169; H04N 19/60

(52) U.S. Cl. CPC H04N 19/597; H04N 19/1883; H04N 19/60

(57) ABSTRACT

Embodiments of the present disclosure provide a solution for point cloud coding. A method for point cloud coding is proposed. The method comprises: determining, for a conversion between a current point cloud (PC) sample of a point cloud sequence and a bitstream of the point cloud sequence, a prediction of a first coefficient for attribute information of a current node in the current PC sample based on a second coefficient for attribute information of a reference node in a reference PC sample associated with the current PC sample; and performing the conversion based on the prediction.

### CROSS REFERENCE TO RELATED APPLICATIONS

This application is a continuation of International Application No. PCT/CN2023/116630, filed on Sep. 1, 2023, which claims the benefit of International Application No. PCT/CN2022/118243, filed on Sep. 9, 2022. The entire contents of these applications are hereby incorporated by reference in their entireties.

### FIELDS

Embodiments of the present disclosure relates generally to point cloud coding techniques, and more particularly, to prediction for point cloud attribute coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a current point cloud (PC) sample of a point cloud sequence and a bitstream of the point cloud sequence, a prediction of a first coefficient for attribute information of a current node in the current PC sample based on a second coefficient for attribute information of a reference node in a reference PC sample associated with the current PC sample; and performing the conversion based on the prediction.

Based on the method in accordance with the first aspect of the present disclosure, a coefficient for attribute information of a reference node in a reference PC sample associated with a current PC sample is utilized to predict a corresponding coefficient for attribute information of a current node in the current PC sample. Compared with the conventional solution, the proposed method can advantageously make use of the temporal and/or spatial redundancy of the attribute information to code the point cloud sequence. Thereby, the coding efficiency of point cloud coding can be improved.

In a second aspect, another method for point cloud coding is proposed. The method comprises: determining, for a conversion between a current point cloud (PC) sample of a point cloud sequence and a bitstream of the point cloud sequence, a prediction of attribute information of a current node in the current PC sample based on attribute information of at least one reference node, wherein the at least one reference node is in the current PC sample or in a reference PC sample associated with the current PC sample; and performing the conversion based on the prediction.

Based on the method in accordance with the second aspect of the present disclosure, attribute information of at least one reference node is utilized to predict attribute information of a current node in the current PC sample. Compared with the conventional solution, the proposed method can advantageously make use of the temporal and/or spatial redundancy of the attribute information to code the point cloud sequence. Thereby, the coding efficiency of point cloud coding can be improved.

In a third aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a fourth aspect, a non-transitory computer-readable storage medium is proposed. The non-transitory computer-readable storage medium stores instructions that cause a processor to perform a method in accordance with the first aspect of the present disclosure.

In a fifth aspect, another non-transitory computer-readable recording medium is proposed. The non-transitory computer-readable recording medium stores a bitstream of a point cloud sequence which is generated by a method performed by an apparatus for point cloud coding. The method comprises: determining a prediction of a first coefficient for attribute information of a current node in a current point cloud (PC) sample of the point cloud sequence based on a second coefficient for attribute information of a reference node in a reference PC sample associated with the current PC sample; and generating the bitstream based on the prediction.

In a sixth aspect, a method for storing a bitstream of a point cloud sequence is proposed. The method comprises: determining a prediction of a first coefficient for attribute information of a current node in a current point cloud (PC) sample of the point cloud sequence based on a second coefficient for attribute information of a reference node in a reference PC sample associated with the current PC sample; generating the bitstream based on the prediction; and storing the bitstream in a non-transitory computer-readable recording medium.

In a seventh aspect, another non-transitory computer-readable recording medium is proposed. The non-transitory computer-readable recording medium stores a bitstream of a point cloud sequence which is generated by a method performed by an apparatus for point cloud coding. The method comprises: determining a prediction of attribute information of a current node in a current point cloud (PC) sample of the point cloud sequence based on attribute information of at least one reference node, wherein the at least one reference node is in the current PC sample or in a reference PC sample associated with the current PC sample; and generating the bitstream based on the prediction.

In an eighth aspect, a method for storing a bitstream of a point cloud sequence is proposed. The method comprises: determining a prediction of attribute information of a current node in a current point cloud (PC) sample of the point cloud sequence based on attribute information of at least one reference node, wherein the at least one reference node is in the current PC sample or in a reference PC sample associated with the current PC sample; generating the bitstream based on the prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates parent-level nodes for each sub-node of transform unit node;

FIG. 5 illustrates a flowchart for an example process of inter prediction of direct current (DC) coefficients;

FIG. 6 illustrates a flowchart of a method for point cloud coding in accordance with embodiments of the present disclosure;

FIG. 7 illustrates a flowchart of a further method for point cloud coding in accordance with embodiments of the present disclosure; and

FIG. 8 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

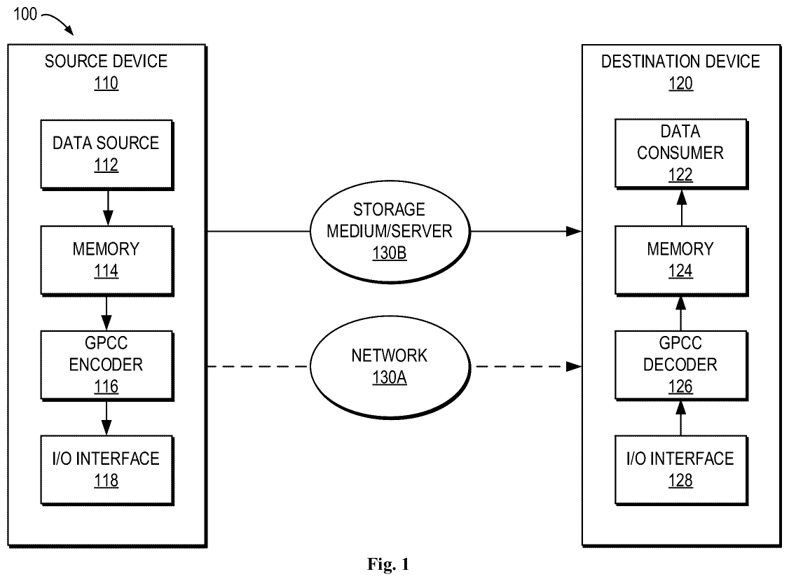

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

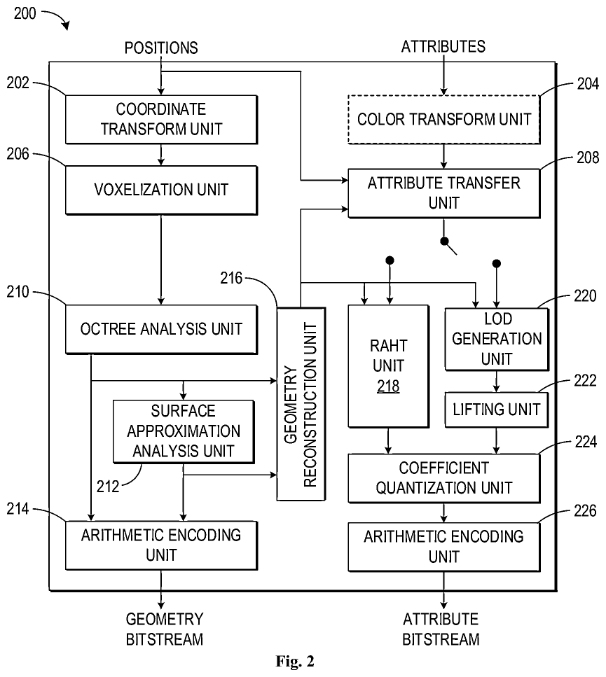

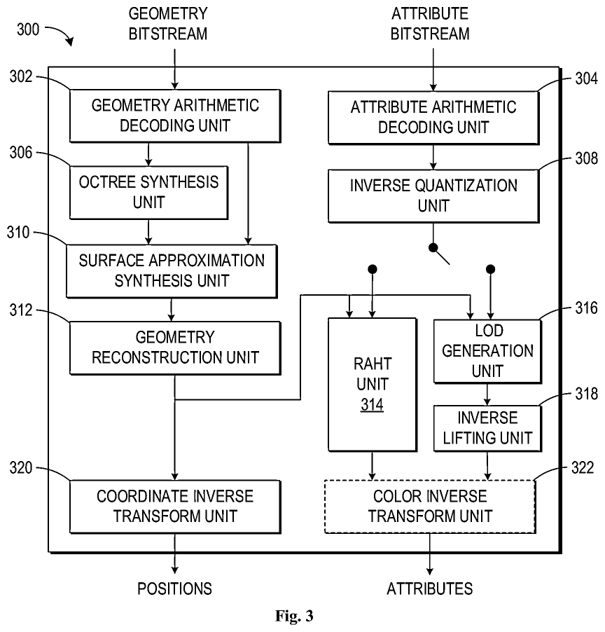

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is related to point cloud attribute prediction in region-adaptive hierarchical transform. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
RAHT Region-Adaptive Hierarchical Transform

### 3. Introduction

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Region-Adaptive Hierarchical Transform

In G-PCC, one of important point cloud attribute coding tools is RAHT. It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level l be g_{l,x,y,z}, for x, y, z integers. g_{l,x,y,z} was obtained by grouping node g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+1,y,z}, with their respective weights, ω_{l,2x,y,z} and w_{l,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

$$where {ω}_{1} = {ω}_{l , 2 x , y , z} and {ω}_{2} = {ω}_{l , 2 x + 1 , y , z} and$$

$${T}_{{ω}_{1} {ω}_{2}} = \frac{1}{\sqrt{{ω}_{1} {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z} .$$

In the last stage, the tree root, the remaining two voxels g_{1,0,0,0} and g_{1,1,0,0} are transformed into the final two coefficients as:

$$[ \begin{matrix}{g}_{D C} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ]$$

where g_{DC}=g_{0,0,0,0}.

### 3.3 Upsampled Transform Domain Prediction in RAHT

The transform domain prediction is introduced to improve coding efficiency on RAHT. It is formed of two parts. Firstly, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Secondly, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side.

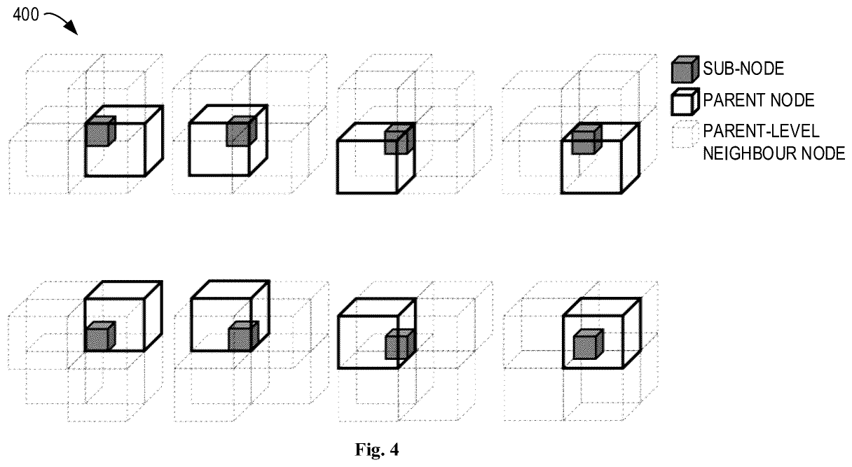

Each sub-node of transform unit node is predicted by 7 parent-level nodes where 3 coline parent-level neighbour nodes, 3 coplane parent-level neighbour nodes and 1 parent node. Coplane and coline neighbours are the neighbours that share a face and an edge with current transform unit node, respectively. FIG. 4 shows a schematic diagram 400 illustrating 7 parent-level nodes for each sub-node of transform unit node.

The attribute aᵤₚ of each sub-node is predicted depending on the distance between it and its parent-level node as follows.

$${a}_{u p} = \sum {ω}_{k} {a}_{k} / \sum {ω}_{k}$$

aₖ is the attribute of its one parent-level node and ωₖ is weight depending on the distance. In G-PCC, ωₚₐᵣₑₙₜ: ω_{coplane}: ω_{coline}=4:2:1.

For AC coefficient, the prediction residual will be signalled.

For DC coefficient, the coefficients are inherited from the previous level, which means that the DC coefficient is signalled without prediction.

### 3.4 Problems

The existing designs for point cloud attribute transform domain prediction in region-adaptive hierarchical transform have the following problems:
1. The DC coefficients may represent the main component of attribute information of one point cloud. Therefore, the DC coefficients are redundant in both temporal order (consecutive point cloud frames) and spatial order (adjacent point cloud segments). However, the current point cloud compression framework lacks the prediction processing for the redundant information, which limits the coding efficiency.
2. The prediction for AC coefficients in current point cloud compression framework use the attribute information at parent level to prediction the attribute information at child level. However, the temporal redundancy of the attribute information at the same level in consecutive point cloud frames is not considered.

### 4. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner. In the following description, the point cloud sample may be referring but not limited to, frame/picture/slice/sub-frame/sub-picture/tile/segment.
1) At least a specific coefficient of at least one reference point cloud sample after transform may be used in the prediction of the corresponding coefficient of another point cloud sample after transform.
   a. In one example, the reference samples and the predicted sample may share the same time stamp. For example, they are adjacent slices in one frame.
   b. Alternatively, the reference samples and the predicted sample may have different time stamps. For example, they come from multiple frames.
   c. In one example, the specific coefficient may be the DC coefficient.
   d. In one example, the specific coefficient of the reference samples may be used to predict the corresponding coefficient of the predicted sample directly or indirectly.
      i. In one example, the specific coefficient of the reference samples may be used as the prediction candidate values.
      ii. Alternatively, the specific coefficient of the reference samples may be used to derive the prediction value.
   e. In one example, the prediction for specific coefficient may be performed at the encoder.
   f. In one example, the prediction for specific coefficient may be performed at the decoder.
2) The prediction residual (a.k.a. difference) of the a specific coefficient and its prediction coefficient may be derived and signalled to the decoder.
   a. In one example, the specific coefficient may be the DC coefficient.
   b. In one example, the residual between the specific coefficient and the prediction value may be derived at the encoder and/or decoder.
   c. In one example, the residual may be signalled to the decoder.
      i. In one example, the residual may be coded with fixed-length coding, unary coding, truncated unary coding, etc. al.
   d. In one example, the residual may be quantized at encoder.
   e. In one example, the residual may be de-quantized at decoder.
3) The attribute information of at least one reference node may be used in the prediction of the attribute information of another one node.
   a. In one example, the reference nodes and the predicted node may share the same time stamp.
   b. Alternatively, the reference nodes and the predicted node may have different time stamps.
4) The attribute information of one reference node in another frame with the same node location may be used in the prediction of the attribute information of one node.
   a. In one example, there may be at least one indication to indicate the node location of each node in one frame.
      i. In one example, the indication may be the Morton code of each node.
      ii. Alternatively, the indication may be the node index and the octree depth index.
      iii. In one example, the indication may be derived at the encoder.
      iv. In one example, the indication may be derived at the decoder.
   b. In one example, the attribute information of the reference node may be used to predict the attribute information of the predicted node directly or indirectly.
      i. In one example, the attribute information of the reference node may be used as the prediction value.
      ii. In one example, the attribute information of the reference node may be used as one prediction candidate value.
      iii. Alternatively, the attribute information of the reference node may be used to derive the prediction value.
         1. In one example, the attribute information of the reference node may be used to calculate the prediction value, such as average weighted sum.
5) The attribute information of multiple reference nodes in another frame may be used in the prediction of the attribute information of one node.
   a. In one example, the reference nodes and the predicted node may share the same octree depth level.
   b. In one example, the reference nodes and the predicted node may have different octree depth level.
   c. In one example, the attribute information of the reference nodes may be used to predict the attribute information of the predicted node directly or indirectly.
      i. In one example, the attribute information of the reference nodes may be used as prediction candidate values.
      ii. Alternatively, the attribute information of the reference nodes may be used to derive the prediction value.
         1. In one example, the attribute information of the reference nodes may be used to calculate the prediction value, such as average weighted sum.
6) In one example, the residual between the predicted attribute and the original attribute may be derived, transformed, and signalled to the decoder.
   a. In one example, the residual between the predicted attribute and the original attribute may be derived at the encoder.
   b. In one example, the residual between the predicted attribute and the original attribute may be derived at the decoder.
   c. In one example, the residual may be transformed and signalled to the decoder.
      i. In one example, the transformed residual may be coded with fixed-length coding, unary coding, truncated unary coding, etc. al.
   d. In one example, the residual or the transformed residual may be quantized at encoder.
   e. In one example, the residual or the transformed residual may be de-quantized at decoder.
7) In one example, the residual between the transformed predicted attribute and the transformed original attribute may be calculated and signalled to the decoder.
   a. In one example, the predicted attribute and the original attribute may be transformed at the encoder.
   b. In one example, the predicted attribute and the original attribute may be transformed at the decoder.
   c. In one example, the residual between the transformed predicted attribute and the transformed original attribute may be derived at the encoder.
   d. In one example, the residual between the transformed predicted attribute and the transformed original attribute may be derived at the decoder.
   e. In one example, the residual of the transformed attribute may be signalled to the decoder.
      i. In one example, the residual may be coded with fixed-length coding, unary coding, truncated unary coding, etc. al.
8) Whether to and/or how to apply a method disclosed above may be signaled from encoder to decoder in a bitstream/frame/tile/slice/octree/etc.
9) Whether to and/or how to apply the disclosed methods above may be dependent on coded information, such as dimensions, colour format, colour component, slice/picture type.

### 5. Embodiments

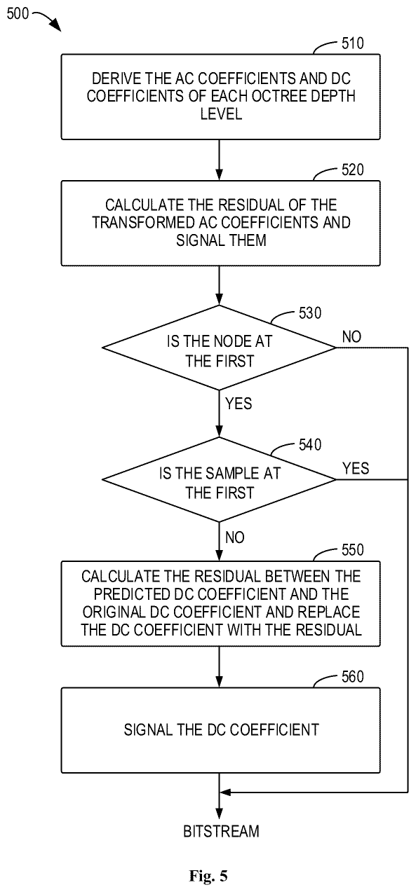

An example of the coding flow for the inter prediction of DC coefficients is depicted in FIG. 5. FIG. 5 illustrates a flowchart 500 for an example process of inter prediction of DC coefficients. At block 510, the AC coefficients and DC coefficients of each octree depth level are derived. At block 520, the residual of the transformed AC coefficients is calculated and the residual is signalled in the bistream. At block 530, it is determined whether the current node is the first node of the current PC sample, i.e., a root node. If not, the processing of the DC coefficients of the current node is skipped. Otherwise, the process proceeds to block 540, where it is determined whether the current PC sample is the first PC sample of the point cloud sequence. If so, the processing of the DC coefficients of the current node is skipped, and the DC coefficients of the current node is coded into the bitstream directly. Otherwise, the process proceeds to block 550. At block 550, the residual between the predicted DC coefficient (i.e., a prediction of the DC coefficient of the current node) and the original DC coefficient (i.e., the DC coefficient of the current node) is calculated. Moreover, the DC coefficient of the current node is replaced with the calculated residual. By way of example, a set of bits originally allocated for the DC coefficient is filled with the calculated residual. At 560, the DC coefficient of the current node is signalled in the bitstream. As mentioned above, the set of bits originally allocated for the DC coefficient is filled with the calculated residual. Therefore, at 560, instead of the the original DC coefficient, it is the calculated residual that is signalled in the bistream.

More details of the embodiments of the present disclosure will be described below which are related to prediction for point cloud attribute coding based on the region-adaptive hierarchical transform (RAHT). The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a picture, a slice, a sub-frame, a sub-picture, a tile, a segment, or any other suitable processing unit.

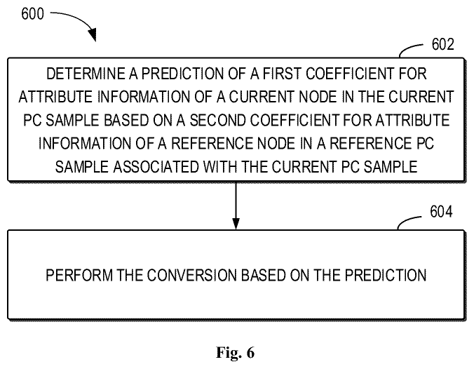

FIG. 6 illustrates a flowchart of a method 600 for point cloud coding in accordance with some embodiments of the present disclosure. The method 600 may be implemented during a conversion between a current PC sample of a point cloud sequence and a bitstream of the point cloud sequence. As shown in FIG. 6, the method 600 starts at 602, where a prediction of a first coefficient for attribute information of a current node in the current PC sample is determined based on a second coefficient for attribute information of a reference node in a reference PC sample associated with the current PC sample.

In some embodiments, the first coefficient may be obtained by performing a region-adaptive hierarchical transform (RAHT) on the attribute information of the current node. The second coefficient may be obtained by performing the RAHT on the attribute information of the reference node. By way of example, each of the first coefficient and the second coefficient may be an alternating current (AC) coefficient. Alternatively, each of the first coefficient and the second coefficient may be a direct current (DC) coefficient. In some embodiments, the RAHT may be performed at an encoder or at a decoder.

In some embodiments, the current node may comprise the current PC sample and the current node may be a root node of a tree structure (such as an octree or the like) for spatial partition of the current PC sample. Similarly, the reference node may comprise the reference PC sample and the reference node may be a root node of a tree structure (such as an octree or the like) for spatial partition of the reference PC sample. In some alternative embodiments, the current node may comprise a part of the current PC sample and the current node may be a non-root node of a tree structure for spatial partition of the current PC sample. Additionally or alternatively, the reference node may comprise a part of the reference PC sample and the reference node may be a non-root node of a tree structure for spatial partition of the reference PC sample. As used herein, the term “non-root node” refers to a node in the tree structure other than the root node. For example, the non-root node may be a child node of the root node or a child node of another non-root node.

By way of example rather than limitation, a DC coefficient for attribute information of a root node of a reference PC sample may be used to predict a DC coefficient for attribute information of a root node of the current PC sample. In other words, the DC coefficient for attribute information is determined based on an inter-PC-sample prediction. Additionally or alternatively, an AC coefficient for attribute information of a non-root node of a reference PC sample may be used to predict an AC coefficient for attribute information of a non-root node of the current PC sample. In other words, the AC coefficient for attribute information is determined based on an inter-PC-sample prediction.

In some embodiments, a time stamp of the reference PC sample may be the same as the current PC sample. For example, the current PC sample and the reference PC sample may be adjacent slices in one frame. Alternatively, the time stamp of the reference PC sample may be different from the current PC sample. For example, the current PC sample and the reference PC sample may be in two different frames.

At 604, the conversion is performed based on the prediction of the first coefficient. In some embodiments the conversion may include encoding the current PC sample into the bitstream. Alternatively or additionally, the conversion may include decoding the current PC sample from the bitstream.

In view of the above, a coefficient for attribute information of a reference node in a reference PC sample associated with a current PC sample is utilized to predict a corresponding coefficient for attribute information of a current node in the current PC sample. Compared with the conventional solution, the proposed method can advantageously make use of the temporal and/or spatial redundancy of the attribute information to code the point cloud sequence. Thereby, the coding efficiency of point cloud coding can be improved.

In some embodiments, at 602, the second coefficient may be used to predict the first coefficient directly or indirectly. In one example, the second coefficient may be determined as the prediction of the first coefficient directly. In another example, a plurality of candidate predictions of the first coefficient are obtained. One of the plurality of candidate predictions is the second coefficient. Furthermore, the prediction of the first coefficient may be determined from the plurality of candidate predictions. In a further example, the prediction of the first coefficient may be determined based on a further processing (such as, quantization, scaling, offsetting or the like) of the second coefficient. It should be understood that the above illustrations are described merely for purpose of description. The scope of the present disclosure is not limited in this respect.

In some embodiments, the prediction of the first coefficient may be determined at an encoder. Additionally or alternatively, the prediction of the first coefficient may be determined at a decoder.

In some embodiments, a residual (a.k.a., difference) between the first coefficient and the prediction of the first coefficient may be determined at an encoder. Moreover, the residual may be indicated in the bitstream. By way of example rather than limitation, the residual may be coded with a fixed-length coding, a unary coding, or a truncated unary coding, or the like.

In some embodiments, the residual may be quantized at the encoder. Additionally or alternatively, the residual may be de-quantized at a decoder.

In some alternative embodiments, the residual between the first coefficient and the prediction of the first coefficient may be determined at a decoder.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a prediction of a first coefficient for attribute information of a current node in a current PC sample of the point cloud sequence is determined based on a second coefficient for attribute information of a reference node in a reference PC sample associated with the current PC sample. Moreover, the bitstream is generated based on the prediction.

According to still further embodiments of the present disclosure, a method for storing a bitstream of a point cloud sequence is provided. According to the method, a prediction of a first coefficient for attribute information of a current node in a current PC sample of the point cloud sequence is determined based on a second coefficient for attribute information of a reference node in a reference PC sample associated with the current PC sample. Moreover, the bitstream is generated based on the prediction, and the bitstream is stored in a non-transitory computer-readable recording medium.

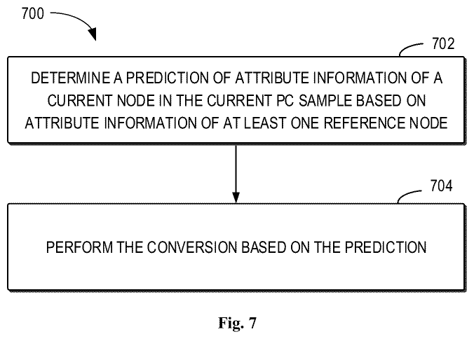

FIG. 7 illustrates a flowchart of a further method 700 for point cloud coding in accordance with some embodiments of the present disclosure. The method 700 may be implemented during a conversion between a current PC sample of a point cloud sequence and a bitstream of the point cloud sequence. As shown in FIG. 7, the method 700 starts at 702, where a prediction of attribute information of a current node in the current PC sample is determined based on attribute information of at least one reference node. The at least one reference node may be in the current PC sample or in a reference PC sample associated with the current PC sample.

In some embodiments, the current node may comprise the current PC sample and the current node may be a root node of a tree structure (such as an octree or the like) for spatial partition of the current PC sample. Similarly, the reference node may comprise the reference PC sample and the reference node may be a root node of a tree structure (such as an octree or the like) for spatial partition of the reference PC sample.

In some alternative embodiments, the current node may comprise a part of the current PC sample and the current node may be a first non-root node of a tree structure for spatial partition of the current PC sample. Additionally or alternatively, the reference node may comprise a part of the current PC sample and the reference node may be a second non-root node of the tree structure for spatial partition of the reference PC sample. The second non-root node is different from the first non-root node. Additionally or alternatively, the reference node may comprise a part of the reference PC sample and the reference node may be a non-root node of a tree structure for spatial partition of the reference PC sample.

In some embodiments, a time stamp of the reference PC sample may be the same as the current PC sample. For example, the current PC sample and the reference PC sample may be adjacent slices in one frame. Alternatively, the time stamp of the reference PC sample may be different from the current PC sample. For example, the current PC sample and the reference PC sample may be in two different frames.

At 704, the conversion is performed based on the prediction of attribute information of the current node. By way of example rather than limitation, the conversion may be performed based on the prediction of attribute information of the current node and the RAHT. That is, the prediction is performed before the transform. On the contrary, in the example embodiments illustrated with reference to FIG. 6, the transform is performed before the prediction. In some embodiments the conversion may include encoding the current PC sample into the bitstream. Alternatively or additionally, the conversion may include decoding the current PC sample from the bitstream.

In view of the above, attribute information of at least one reference node is utilized to predict attribute information of a current node in the current PC sample. Compared with the conventional solution, the proposed method can advantageously make use of the temporal and/or spatial redundancy of the attribute information to code the point cloud sequence. Thereby, the coding efficiency of point cloud coding can be improved.

In some embodiments, the at least one reference node may comprise a single reference node in the reference PC sample. Additionally, a node location of the single reference node may be the same as the current node. The node location of the single reference node may be indicated by at least one indication. In one example, the at least one indication may comprise a Morton code of the single reference node. Additionally or alternatively, the at least one indication may comprise a node index of the single reference node, an octree depth index of the single reference node, and/or the like. The at least one indication may be determined at an encoder or at a decoder.

In some embodiments, at 702, the attribute information of the single reference node may be used to predict the attribute information of the current node directly or indirectly. In one example, the attribute information of single reference node may be determined as the prediction of attribute information of the current node directly. In another example, a plurality of candidate predictions of attribute information of the current node may be obtained. One of the plurality of candidate predictions is the attribute information of single reference node. Furthermore, the prediction of attribute information of the current node may be determined from the plurality of candidate predictions.

In a further example, the prediction of attribute information of the current node may be determined based on a further processing (such as, quantization, scaling, offsetting or the like) of the attribute information of single reference node. In a still further example, a plurality of candidate predictions of attribute information of the current node may be obtained. One of the plurality of candidate predictions is the attribute information of single reference node. Moreover, the prediction of attribute information of the current node may be determined based on an average weighted sum of the plurality of candidate predictions. It should be understood that the above illustrations are described merely for purpose of description. The scope of the present disclosure is not limited in this respect.

In some embodiments, the at least one reference node may comprise a plurality of reference nodes in the reference PC sample. For example, an octree depth level of each of the plurality of reference nodes may be the same as the current node. Alternatively, an octree depth level of at least one of the plurality of reference nodes may be different from the current node.

In some embodiments, at 702, the attribute information of the plurality of reference nodes may be used to predict the attribute information of the current node directly or indirectly. In one example, the attribute information of one of the plurality of reference nodes may be determined as the prediction of attribute information of the current node. In another example, a plurality of candidate predictions of attribute information of the current node may be obtained. One of the plurality of candidate predictions is the attribute information of one of the plurality of reference nodes. Furthermore, the prediction of attribute information of the current node may be determined from the plurality of candidate predictions.

In a further example, the prediction of attribute information of the current node may be determined based on a further processing (such as, quantization, scaling, offsetting or the like) of the attribute information of the plurality of reference nodes. In a still further example, a plurality of candidate predictions of attribute information of the current node may be obtained. One of the plurality of candidate predictions is the attribute information of one of the plurality of reference nodes. Moreover, the prediction of attribute information of the current node may be determined based on an average weighted sum of the plurality of candidate predictions.

In some embodiments, a residual between the attribute information of the current node and the prediction of the attribute information of the current node may be determined at an encoder. Additionally, a coefficient for the residual may be obtained by performing an RAHT on the residual, and the coefficient may be indicated in the bitstream. It should be noted that a coefficient for the residual may also be referred to as a transformed residual.

By way of example rather than limitation, the coefficient may be coded with a fixed-length coding, a unary coding, a truncated unary coding, or the like. In some embodiments, the coefficient may be quantized at the encoder or at a decoder. In some embodiments, the residual may be quantized at the encoder. Additionally, the residual may be de-quantized at a decoder.

In some alternative embodiments, a residual between the attribute information of the current node and the prediction of the attribute information of the current node may be determined at a decoder.

In some embodiments, information regarding whether to and/or how to apply the method may be indicated in the bitstream. Additionally or alternatively, the information regarding whether to and/or how to apply the method may be indicated in a frame, a tile, a slice, an octree, or the like.

In some embodiments, information regarding whether to and/or how to apply the method may be dependent on coded information. By way of example rather than limitation, the coded information may comprise a dimension, a color format, a color component, a slice type, a picture type, and/or the like.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a prediction of attribute information of a current node in a current point cloud (PC) sample of the point cloud sequence is determined based on attribute information of at least one reference node. The at least one reference node is in the current PC sample or in a reference PC sample associated with the current PC sample. Moreover, the bitstream is generated based on the prediction.

According to still further embodiments of the present disclosure, a method for storing a bitstream of a point cloud sequence is provided. According to the method, a prediction of attribute information of a current node in a current point cloud (PC) sample of the point cloud sequence is determined based on attribute information of at least one reference node. The at least one reference node is in the current PC sample or in a reference PC sample associated with the current PC sample. Moreover, the bitstream is generated based on the prediction, and the bitstream is stored in a non-transitory computer-readable recording medium.

Implementations of the present disclosure can be described in view of the following clauses, the features of which can be combined in any reasonable manner.

Clause 1. A method for point cloud coding, comprising: determining, for a conversion between a current point cloud (PC) sample of a point cloud sequence and a bitstream of the point cloud sequence, a prediction of a first coefficient for attribute information of a current node in the current PC sample based on a second coefficient for attribute information of a reference node in a reference PC sample associated with the current PC sample; and performing the conversion based on the prediction.

Clause 2. The method of clause 1, wherein the first coefficient is obtained by performing a region-adaptive hierarchical transform (RAHT) on the attribute information of the current node, and the second coefficient is obtained by performing the RAHT on the attribute information of the reference node.

Clause 3. The method of any of clauses 1-2, wherein each of the first coefficient and the second coefficient is an alternating current (AC) coefficient, or each of the first coefficient and the second coefficient is a direct current (DC) coefficient.

Clause 4. The method of any of clauses 1-3, wherein the current node comprises the current PC sample and is a root node of a tree structure for spatial partition of the current PC sample, and the reference node comprises the reference PC sample and is a root node of a tree structure for spatial partition of the reference PC sample.

Clause 5. The method of any of clauses 1-3, wherein the current node comprises a part of the current PC sample and is a non-root node of a tree structure for spatial partition of the current PC sample, or wherein the reference node comprises a part of the reference PC sample and is a non-root node of a tree structure for spatial partition of the reference PC sample.

Clause 6. The method of any of clauses 1-5, wherein a time stamp of the reference PC sample is the same as the current PC sample.

Clause 7. The method of any of clauses 1-5, wherein a time stamp of the reference PC sample is different from the current PC sample.

Clause 8. The method of any of clauses 1-7, wherein determining the prediction comprises: determining the second coefficient as the prediction of the first coefficient.

Clause 9. The method of any of clauses 1-7, wherein determining the prediction comprises: obtaining a plurality of candidate predictions of the first coefficient, one of the plurality of candidate predictions being the second coefficient; and determining the prediction of the first coefficient from the plurality of candidate predictions.

Clause 10. The method of any of clauses 1-7, wherein determining the prediction comprises: determining the prediction based on a further processing of the second coefficient.

Clause 11. The method of any of clauses 1-10, wherein the prediction of the first coefficient is determined at an encoder.

Clause 12. The method of any of clauses 1-10, wherein the prediction of the first coefficient is determined at a decoder.

Clause 13. The method of any of clauses 1-12, wherein a residual between the first coefficient and the prediction of the first coefficient is determined at an encoder.

Clause 14. The method of clause 13, wherein the residual is indicated in the bitstream.

Clause 15. The method of clause 14, wherein the residual is coded with one of the following: a fixed-length coding, a unary coding, or a truncated unary coding.

Clause 16. The method of any of clauses 13-15, wherein the residual is quantized at the encoder.

Clause 17. The method of any of clauses 13-16, wherein the residual is de-quantized at a decoder.

Clause 18. The method of any of clauses 1-12, wherein a residual between the first coefficient and the prediction of the first coefficient is determined at a decoder.

Clause 19. The method of any of clauses 2-18, wherein the RAHT is performed at an encoder.

Clause 20. The method of any of clauses 2-18, wherein the RAHT is performed at a decoder.

Clause 21. A method for point cloud coding, comprising: determining, for a conversion between a current point cloud (PC) sample of a point cloud sequence and a bitstream of the point cloud sequence, a prediction of attribute information of a current node in the current PC sample based on attribute information of at least one reference node, wherein the at least one reference node is in the current PC sample or in a reference PC sample associated with the current PC sample; and performing the conversion based on the prediction.

Clause 22. The method of any of clause 21, wherein the current node comprises the current PC sample and is a root node of a tree structure for spatial partition of the current PC sample, and the reference node comprises the reference PC sample and is a root node of a tree structure for spatial partition of the reference PC sample.

Clause 23. The method of clause 21, wherein the current node comprises a part of the current PC sample and is a first non-root node of a tree structure for spatial partition of the current PC sample, or wherein the reference node comprises a part of the current PC sample and is a second non-root node of the tree structure for spatial partition of the reference PC sample, the second non-root node being different from the first non-root node, or wherein the reference node comprises a part of the reference PC sample and is a non-root node of a tree structure for spatial partition of the reference PC sample.

Clause 24. The method of any of clauses 21-23, wherein a time stamp of the reference PC sample is the same as the current PC sample.

Clause 25. The method of any of clauses 21-23, wherein a time stamp of the reference PC sample is different from the current PC sample.

Clause 26. The method of any of clauses 21-25, wherein the at least one reference node comprises a single reference node in the reference PC sample.

Clause 27. The method of clause 26, wherein a node location of the single reference node is the same as the current node.

Clause 28. The method of clause 27, wherein the node location of the single reference node is indicated by at least one indication.

Clause 29. The method of clause 28, wherein the at least one indication comprises a Morton code of the single reference node.

Clause 30. The method of clause 28, wherein the at least one indication comprises at least one of a node index of the single reference node or an octree depth index of the single reference node.

Clause 31. The method of any of clauses 28-30, wherein the at least one indication is determined at an encoder.

Clause 32. The method of any of clauses 28-30, wherein the at least one indication is determined at a decoder.

Clause 33. The method of any of clauses 26-32, wherein determining the prediction comprises: determining the attribute information of single reference node as the prediction of attribute information of the current node.

Clause 34. The method of any of clauses 26-32, wherein determining the prediction comprises: obtaining a plurality of candidate predictions of attribute information of the current node, one of the plurality of candidate predictions being the attribute information of single reference node; and determining the prediction of attribute information of the current node from the plurality of candidate predictions.

Clause 35. The method of any of clauses 26-32, wherein determining the prediction comprises: determining the prediction based on a further processing of the attribute information of single reference node.

Clause 36. The method of any of clauses 26-32, wherein determining the prediction comprises: obtaining a plurality of candidate predictions of attribute information of the current node, one of the plurality of candidate predictions being the attribute information of single reference node; and determining the prediction of attribute information of the current node based on an average weighted sum of the plurality of candidate predictions.

Clause 37. The method of any of clauses 21-25, wherein the at least one reference node comprises a plurality of reference nodes in the reference PC sample.

Clause 38. The method of clause 37, wherein an octree depth level of each of the plurality of reference nodes is the same as the current node.

Clause 39. The method of clause 37, wherein an octree depth level of at least one of the plurality of reference nodes is different from the current node.

Clause 40. The method of any of clauses 37-39, wherein determining the prediction comprises: determining the attribute information of one of the plurality of reference nodes as the prediction of attribute information of the current node.

Clause 41. The method of any of clauses 37-39, wherein determining the prediction comprises: obtaining a plurality of candidate predictions of attribute information of the current node, one of the plurality of candidate predictions being the attribute information of one of the plurality of reference nodes; and determining the prediction of attribute information of the current node from the plurality of candidate predictions.

Clause 42. The method of any of clauses 37-39, wherein determining the prediction comprises: determining the prediction based on a further processing of the attribute information of the plurality of reference nodes.

Clause 43. The method of any of clauses 37-39, wherein determining the prediction comprises: obtaining a plurality of candidate predictions of attribute information of the current node, one of the plurality of candidate predictions being the attribute information of one of the plurality of reference nodes; and determining the prediction of attribute information of the current node based on an average weighted sum of the plurality of candidate predictions.

Clause 44. The method of any of clauses 21-43, wherein a residual between the attribute information of the current node and the prediction of the attribute information of the current node is determined at an encoder.

Clause 45. The method of clause 44, wherein a coefficient for the residual is obtained by performing a region-adaptive hierarchical transform (RAHT) on the residual, and the coefficient is indicated in the bitstream.

Clause 46. The method of clause 45, wherein the coefficient is coded with one of the following: a fixed-length coding, a unary coding, or a truncated unary coding.

Clause 47. The method of any of clauses 45-46, wherein the coefficient is quantized at the encoder.

Clause 48. The method of any of clauses 45-47, wherein the coefficient is de-quantized at a decoder.

Clause 49. The method of any of clauses 44-48, wherein the residual is quantized at the encoder.

Clause 50. The method of any of clauses 44-49, wherein the residual is de-quantized at a decoder.

Clause 51. The method of any of clauses 21-43, wherein a residual between the attribute information of the current node and the prediction of the attribute information of the current node is determined at a decoder.

Clause 52. The method of any of clauses 1-51, wherein a PC sample is one of the following: a frame, a picture, a slice, a sub-frame, a sub-picture, a tile, or a segment.

Clause 53. The method of any of clauses 1-52, wherein information regarding whether to and/or how to apply the method is indicated in the bitstream.

Clause 54. The method of any of clauses 1-53, wherein information regarding whether to and/or how to apply the method is indicated in one of the following: a frame, a tile, a slice, or an octree.

Clause 55. The method of any of clauses 1-54, wherein information regarding whether to and/or how to apply the method is dependent on coded information.

Clause 56. The method of clause 55, wherein the coded information comprises at least one of the following: a dimension, a color format, a color component, a slice type, or a picture type.

Clause 57. The method of any of clauses 1-56, wherein the conversion includes encoding the current PC sample into the bitstream.

Clause 58. The method of any of clauses 1-56, wherein the conversion includes decoding the current PC sample from the bitstream.

Clause 59. An apparatus for point cloud coding comprising a processor and a non-transitory memory with instructions thereon, wherein the instructions upon execution by the processor, cause the processor to perform a method in accordance with any of clauses 1-20.

Clause 60. A non-transitory computer-readable storage medium storing instructions that cause a processor to perform a method in accordance with any of clauses 1-20.

Clause 61. A non-transitory computer-readable recording medium storing a bitstream of a point cloud sequence which is generated by a method performed by an apparatus for point cloud coding, wherein the method comprises: determining a prediction of a first coefficient for attribute information of a current node in a current point cloud (PC) sample of the point cloud sequence based on a second coefficient for attribute information of a reference node in a reference PC sample associated with the current PC sample; and generating the bitstream based on the prediction.

Clause 62. A method for storing a bitstream of a point cloud sequence, comprising: determining a prediction of a first coefficient for attribute information of a current node in a current point cloud (PC) sample of the point cloud sequence based on a second coefficient for attribute information of a reference node in a reference PC sample associated with the current PC sample; generating the bitstream based on the prediction; and storing the bitstream in a non-transitory computer-readable recording medium.

Clause 63. A non-transitory computer-readable recording medium storing a bitstream of a point cloud sequence which is generated by a method performed by an apparatus for point cloud coding, wherein the method comprises: determining a prediction of attribute information of a current node in a current point cloud (PC) sample of the point cloud sequence based on attribute information of at least one reference node, wherein the at least one reference node is in the current PC sample or in a reference PC sample associated with the current PC sample; and generating the bitstream based on the prediction.

Clause 64. A method for storing a bitstream of a point cloud sequence, comprising: determining a prediction of attribute information of a current node in a current point cloud (PC) sample of the point cloud sequence based on attribute information of at least one reference node, wherein the at least one reference node is in the current PC sample or in a reference PC sample associated with the current PC sample; generating the bitstream based on the prediction; and storing the bitstream in a non-transitory computer-readable recording medium.

### Example Device

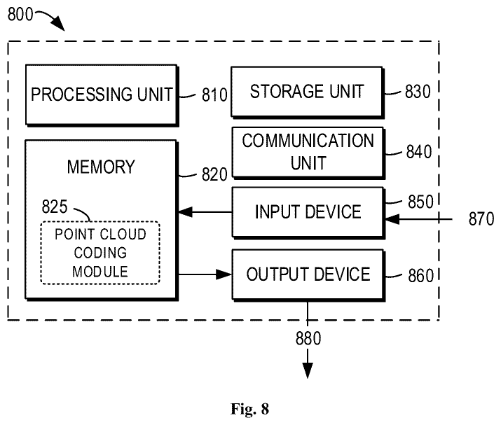

FIG. 8 illustrates a block diagram of a computing device 800 in which various embodiments of the present disclosure can be implemented. The computing device 800 may be implemented as or included in the source device 110 (or the GPCC encoder 116 or 200) or the destination device 120 (or the GPCC decoder 126 or 300).

It would be appreciated that the computing device 800 shown in FIG. 8 is merely for purpose of illustration, without suggesting any limitation to the functions and scopes of the embodiments of the present disclosure in any manner.

As shown in FIG. 8, the computing device 800 includes a general-purpose computing device 800. The computing device 800 may at least comprise one or more processors or processing units 810, a memory 820, a storage unit 830, one or more communication units 840, one or more input devices 850, and one or more output devices 860.

In some embodiments, the computing device 800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 800 can support any type of interface to a user (such as “wearable” circuitry and the like).

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem and the like) enabling the computing device 800 to communicate with one or more other computing devices, if required. Such communication can be performed via input/output (I/O) interfaces (not shown).

In some embodiments, instead of being integrated in a single device, some or all components of the computing device 800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 800 may be used to implement point cloud encoding/decoding in embodiments of the present disclosure. The memory 820 may include one or more point cloud coding modules 825 having one or more program instructions. These modules are accessible and executable by the processing unit 810 to perform the functionalities of the various embodiments described herein.

In the example embodiments of performing point cloud encoding, the input device 850 may receive point cloud data as an input 870 to be encoded. The point cloud data may be processed, for example, by the point cloud coding module 825, to generate an encoded bitstream. The encoded bitstream may be provided via the output device 860 as an output 880.

In the example embodiments of performing point cloud decoding, the input device 850 may receive an encoded bitstream as the input 870. The encoded bitstream may be processed, for example, by the point cloud coding module 825, to generate decoded point cloud data. The decoded point cloud data may be provided via the output device 860 as the output 880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, for a first conversion between a first point cloud (PC) sample of a point cloud sequence and a bitstream of the point cloud sequence, a prediction of a first coefficient for attribute information of a first node in the first PC sample based on a second coefficient for attribute information of a reference node in a reference PC sample associated with the first PC sample; and
performing the first conversion based on the prediction.

2. The method of claim 1, wherein the first coefficient is obtained by performing a region-adaptive hierarchical transform (RAHT) on the attribute information of the first node, and the second coefficient is obtained by performing the RAHT on the attribute information of the reference node.

3. The method of claim 1, wherein each of the first coefficient and the second coefficient is an alternating current (AC) coefficient, or each of the first coefficient and the second coefficient is a direct current (DC) coefficient, or
wherein the first node comprises the first PC sample and is a root node of a tree structure for spatial partition of the first PC sample, and the reference node comprises the reference PC sample and is a root node of a tree structure for spatial partition of the reference PC sample, or
wherein the first node comprises a part of the first PC sample and is a non-root node of a tree structure for spatial partition of the first PC sample, or
wherein the reference node comprises a part of the reference PC sample and is a non-root node of a tree structure for spatial partition of the reference PC sample.

4. The method of claim 1, wherein a time stamp of the reference PC sample is the same as the first PC sample, or
wherein a time stamp of the reference PC sample is different from the first PC sample, or
wherein determining the prediction comprises: determining the second coefficient as the prediction of the first coefficient, or
wherein determining the prediction comprises: obtaining a plurality of candidate predictions of the first coefficient, one of the plurality of candidate predictions being the second coefficient; and determining the prediction of the first coefficient from the plurality of candidate predictions, or
wherein determining the prediction comprises: determining the prediction based on a further processing of the second coefficient, or
wherein the prediction of the first coefficient is determined at an encoder, or
wherein the prediction of the first coefficient is determined at a decoder, or
wherein a residual between the first coefficient and the prediction of the first coefficient is determined at a decoder.

5. The method of claim 1, wherein a residual between the first coefficient and the prediction of the first coefficient is determined at an encoder, or
wherein the residual is indicated in the bitstream.

6. The method of claim 5, wherein the residual is coded with one of the following: a fixed-length coding, a unary coding, or a truncated unary coding, or
wherein the residual is quantized at the encoder, or
wherein the residual is de-quantized at a decoder.

7. The method of claim 2, wherein the RAHT is performed at an encoder, or
wherein the RAHT is performed at a decoder.

8. The method of claim 1, further comprising:
determining, for a second conversion between a second point cloud (PC) sample of a point cloud sequence and a bitstream of the point cloud sequence, a prediction of attribute information of a second node in the second PC sample based on attribute information of at least one reference node, wherein the at least one reference node is in the second PC sample or in a reference PC sample associated with the second PC sample; and
performing the second conversion based on the prediction of the attribute information.

9. The method of claim 8, wherein the second node comprises the second PC sample and is a root node of a tree structure for spatial partition of the second PC sample, and the reference node comprises the reference PC sample and is a root node of a tree structure for spatial partition of the reference PC sample, or
wherein the second node comprises a part of the second PC sample and is a first non-root node of a tree structure for spatial partition of the second PC sample, or
wherein the reference node comprises a part of the second PC sample and is a second non-root node of the tree structure for spatial partition of the reference PC sample, the second non-root node being different from the first non-root node, or
wherein the reference node comprises a part of the reference PC sample and is a non-root node of a tree structure for spatial partition of the reference PC sample.

10. The method of claim 8, wherein a time stamp of the reference PC sample is the same as the second PC sample, or
wherein a time stamp of the reference PC sample is different from the second PC sample.

11. The method of claim 8, wherein the at least one reference node comprises a single reference node in the reference PC sample.

12. The method of claim 11, wherein a node location of the single reference node is the same as the second node.

13. The method of claim 12, wherein the node location of the single reference node is indicated by at least one indication.

14. The method of claim 13, wherein the at least one indication comprises a Morton code of the single reference node, or
wherein the at least one indication comprises at least one of a node index of the single reference node or an octree depth index of the single reference node, or
wherein the at least one indication is determined at an encoder, or
wherein the at least one indication is determined at a decoder.

15. The method of claim 11, wherein determining the prediction of the attribute information comprises:
determining the attribute information of single reference node as the prediction of attribute information of the second node, or
wherein determining the prediction of the attribute information comprises: obtaining a plurality of candidate predictions of attribute information of the second node, one of the plurality of candidate predictions being the attribute information of single reference node; and determining the prediction of attribute information of the second node from the plurality of candidate predictions, or
wherein determining the prediction of the attribute information comprises: determining the prediction based on a further processing of the attribute information of single reference node, or
wherein determining the prediction of the attribute information comprises: obtaining a plurality of candidate predictions of attribute information of the second node, one of the plurality of candidate predictions being the attribute information of single reference node; and determining the prediction of attribute information of the second node based on an average weighted sum of the plurality of candidate predictions.

16. The method of claim 1, wherein a PC sample is one of the following:
a frame,
a picture,
a slice,
a sub-frame,
a sub-picture,
a tile, or
a segment.

17. The method of claim 1, wherein the conversion includes encoding the first PC sample into the bitstream, or
wherein the conversion includes decoding the first PC sample from the bitstream.

18. An apparatus for point cloud coding comprising a processor and a non-transitory memory with instructions thereon, wherein the instructions upon execution by the processor, cause the processor to perform acts comprising:
determining, for a first conversion between a first point cloud (PC) sample of a point cloud sequence and a bitstream of the point cloud sequence, a prediction of a first coefficient for attribute information of a first node in the first PC sample based on a second coefficient for attribute information of a reference node in a reference PC sample associated with the first PC sample; and
performing the first conversion based on the prediction.

19. A non-transitory computer-readable storage medium storing instructions that cause a processor to perform acts comprising:
determining, for a first conversion between a first point cloud (PC) sample of a point cloud sequence and a bitstream of the point cloud sequence, a prediction of a first coefficient for attribute information of a first node in the first PC sample based on a second coefficient for attribute information of a reference node in a reference PC sample associated with the first PC sample; and
performing the first conversion based on the prediction.

20. A non-transitory computer-readable recording medium storing a bitstream of a point cloud sequence which is generated by a method performed by an apparatus for point cloud coding, wherein the method comprises:
determining a prediction of a first coefficient for attribute information of a first node in a first point cloud (PC) sample of the point cloud sequence based on a second coefficient for attribute information of a reference node in a reference PC sample associated with the first PC sample; and
generating the bitstream based on the prediction.
